(19) United States
(12) Patent Application Publication
(10) Pub. No.: US 2007/0154047 A1
(43) Pub. Date: Jul. 5, 2007

(54) Electroinc media player for playing a single collection of data

(76) Inventors: Jacqueline Ann Coyne, Jefferson, IA (US); Katherine Rinaldi Meals, San Jose, CA (US)

Correspondence Address: Jacqueline Coyne, 4403 Chamberlin ave, Des Moines, IA, 50312, US

(21) Appl. No.: 11/322,629

(22) Filed: Dec. 30, 2005

(51) Int. Cl. H04R 25/00

(52) U.S. Cl. 381/370

(57) ABSTRACT

A set of headphones for playing a single audio album or song is disclosed. The set of headphones includes an electronic media player and pre-programmed audio data, such as a music album. The pre-programmed audio data cannot be added to or deleted or otherwise altered by a user, and the headphones can only be used to enjoy the pre-programmed audio selection.

### FIELD OF THE INVENTION

Embodiments of the present invention relate to electronic media players. More specifically, embodiments of the present invention relate to a compact electric device for playing a single album or movie.

### BACKGROUND OF THE INVENTION

Goods that are disposable and easy to acquire are trademarks of our current economy, for better or worse. Today's consumer prefers to get what she wants the moment she wants it. Waiting is not attractive—waiting is becoming obsolete. For example, music. The moment a new song comes out, a consumer can click her way to a website and download that song onto her computer at a very minimal cost. From there, she can download it onto her portable media player and enjoy the song as she goes about her commute or her daily jog. When she tires of the song, she can simply delete it from her media player and forget about it. The song is disposable. The method of acquiring it and enjoying it was cheap and easy.

Another example is photography. Say our consumer wants to be able to take pictures at her friend's wedding. Of course she might like to have a nice sleek digital camera, but say she lacks the funds or the knowledge to buy a new camera. One option is to purchase a disposable camera, preloaded with film. So she takes her disposable camera to the wedding, takes a handful of pictures, turns in the camera at the corner drugstore on Monday and that afternoon she has her memories in hand. The camera is disposable and cheap, and gets the job done.

Back to music, we as consumers currently have lots of options as far as how we acquire and enjoy music. For example, one can choose an Apple iPod. However, an iPod is not within the daily or weekly budget of many consumers, whereas a single compact disc (CD) is within their daily or weekly budget. So a typical consumer can afford a new CD or two on a weekend shopping trip. But what does our consumer do when she wants to enjoy that new CD while she commutes or jogs and she can't afford the ipod or the mp3 player? She may save her pennies so she can acquire some sort of compact media player, but she does not have any immediate solution. Today's economy trains us all to demand immediate gratification. The invention proposed in this application will provide a means of immediate gratification in the area of music consumption.

### SUMMARY OF THE INVENTION

Embodiments of the present invention, an electronic media player for playing a single collection of data, are presented. A set of headphones is presented that includes an electronic media player, speakers and a battery. The headphones further comprise a pre-programmed set of non-erasable, non-rewritable audio data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a set of headphones in accordance with an embodiment of the present invention.

FIG. 2 is a hand-held video player in accordance with an embodiment of the present invention.

FIG. 3 is a device for dispensing data to an electronic media player, in accordance with an embodiment of the present invention.

FIG. 4 depicts a jukebox vending machine in accordance with an embodiment of the present invention.

### DETAILED DESCRIPTION

Reference will now be made in detail to various embodiments of the invention, examples of which are illustrated in the accompanying drawings. While the invention will be described in conjunction with various embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

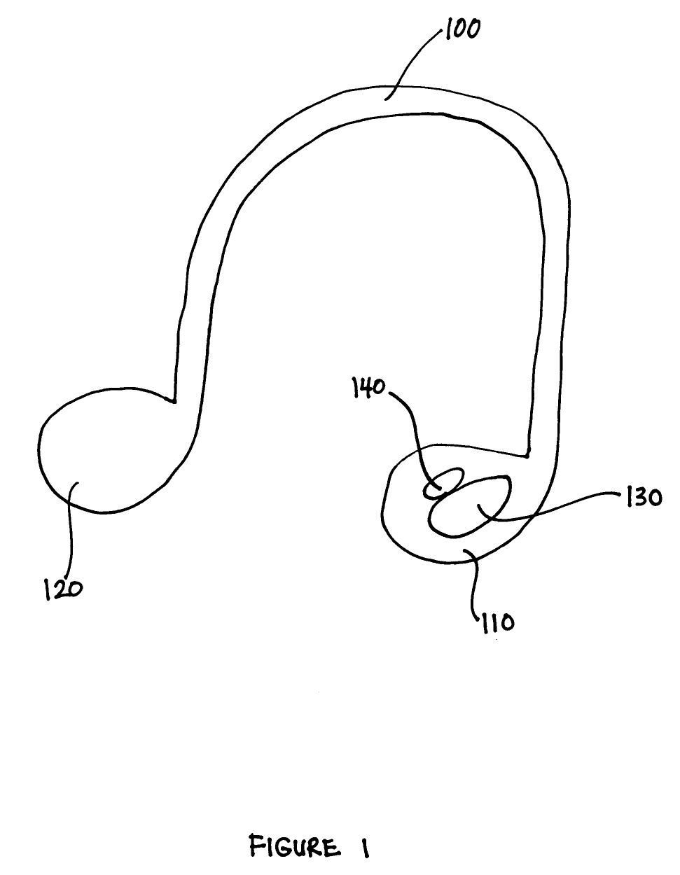

An embodiment of the present invention is a set of headphones 100, as illustrated in FIG. 1, that contain an electronic audio player 130, a right headphone 120, a left headphone 130 and a battery 140. The headphones 100 of the present invention are pre-programmed with a certain set of audio data, for example one song or one album. For example, Madonna's new album “Confessions on a Dance Floor.”

A consumer who purchases the headphones 100 cannot modify the contents of the electronic media player 130. For example, the consumer/user cannot add new songs or delete any of the pre-programmed songs. In the Madonna example, the headphones are Madonna headphones, and they can only be used to play Confessions on a Dance Floor. In one embodiment, the user could choose to play one track on the album repeatedly, or skip around the album. In another embodiment, the user could only listen to the album in the order it was assembled by the music company, without skipping around or repeating any tracks. In one embodiment, the user could only listen to the album one time through. In another embodiment, the user could listen to the album a predetermined number of times, for example 12. In a preferred embodiment, the user could listen to the album an unlimited number of times.

In a preferred embodiment, the headphones 100 of the present invention lack any additional parts. The battery 140 and the media player 130 are parts of the headphones 100. Since only one album is being stored on the media player, and the data is not re-writable or alterable by the user at all, the space required for electronic circuitry is minimal. In a preferred embodiment, the headphones 100 also include an on/off switch, a volume control button or dial, and a control button or dial for selecting a track on the pre-programmed album. These additional features are not depicted in FIG. 1.

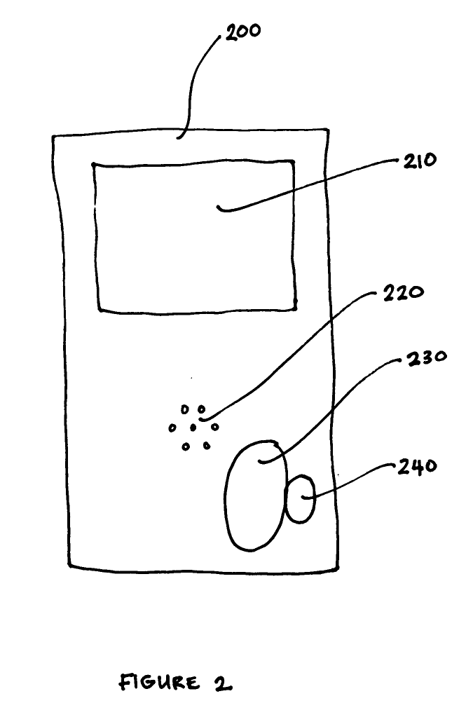

Another embodiment of the present invention is illustrated in FIG. 2. In this embodiment, the media is video data. FIG. 2 illustrates a hand held video display device 200 that includes a display screen 210, a speaker 220, an electronic media player 230 and a battery 240. The video display device 200 of the present invention is pre-programmed with a certain set of video data, for example one episode of a television show, one music video, a plurality of music videos, or one movie. For example, Sarah Silverman's new movie “Jesus is Magic.”

A consumer who purchases the video display device 200 cannot modify the contents of the electronic media player 230. For example, the consumer/user cannot add new movies or delete the original movie. In the Sarah Silverman example, the video player is a Sarah Silverman video player, and it can only be used to show “Jesus is Magic.” In one embodiment, the user could choose to play one scene of the movie repeatedly, or skip around the movie. In another embodiment, the user could only watch the movie in the order it was assembled by the film company, without skipping around or repeating any scenes. In one embodiment, the user could only watch the movie one time through. In another embodiment, the user could watch the movie a predetermined number of times, for example 12. In a preferred embodiment, the user could watch the movie an unlimited number of times.

In a preferred embodiment, the video display device 200 of the present invention lacks any additional parts. The battery 240 and the media player 230 are parts of the device 200. Since only one movie is being stored on the media player, and the data is not re-writable or alterable by the user at all, the space required for electronic circuitry is minimal. In preferred embodiment, the device 200 also includes an on/off switch, a volume control button or dial, and a control button or dial for selecting a scene in the movie/show/video. These additional features are not depicted in FIG. 2.

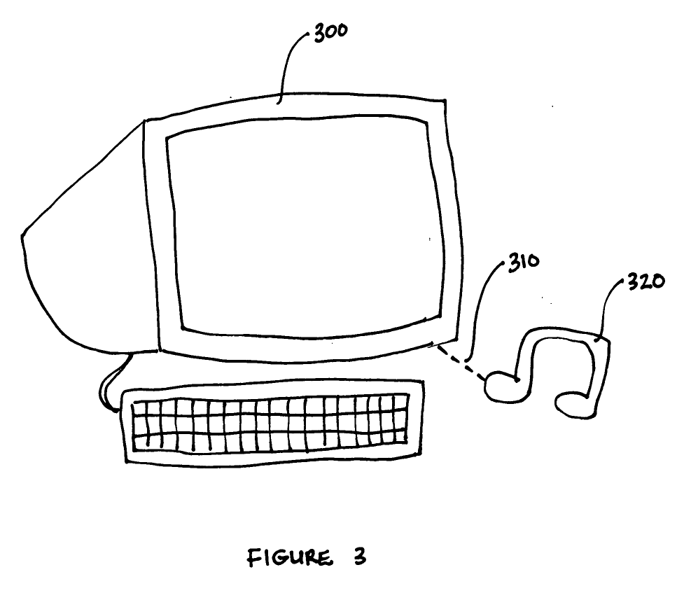

FIG. 3 illustrates an additional embodiment of the present invention, a device 300 for dispensing data onto a media player contained in a device like the headphones 100 of FIG. 1 or the video display device of FIG. 2. In the depiction of FIG. 3, the device 300 is a personal computer, but other devices could be employed, such as a jukebox in a record store or coffee shop. In one embodiment, the device 300 in FIG. 3 accesses audio or video data from the internet and writes the audio or video data to a device 320, e.g. the headphones 100 of FIG. 1 or the video display device 200 of FIG. 2 via a connection 310. As depicted in FIG. 3, the connection 310 could be a wireless connection. In another embodiment, the connection 310 could be a USB cord or other means.

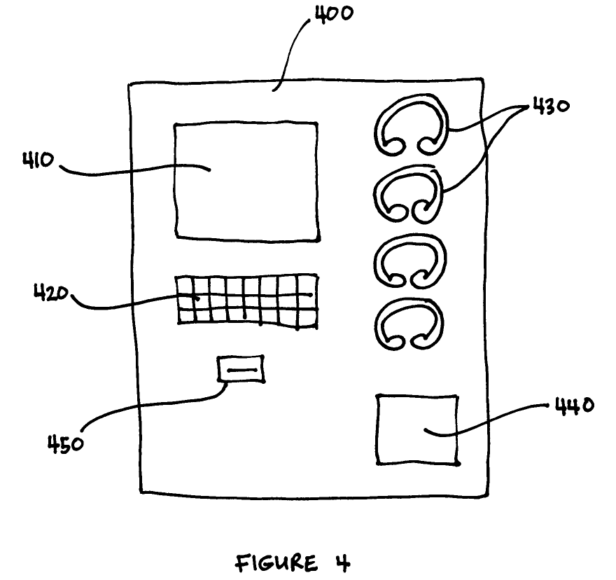

Once the audio or video data is written to the media playing device 320, the data is not erasable or re-writable. A user cannot alter data once it is written to the media playing device 320. For example, the device 300 could be a jukebox vending machine 400, as depicted in FIG. 4.

A consumer could walk in to a music store where she finds a vending machine 400 such as the one depicted in FIG. 4. She uses the display screen 410 and the keyboard 420, (or a mouse or a touch-sensitive screen, in other embodiments) to select a new album, for example Franz Ferdinand's self-titled album. The consumer slides her credit card or inserts cash in a slot 450, and a set of headphones 430 like the one depicted in FIG. 1 and described above is programmed by a computer within the vending machine 400 with the entire Franz Ferdinand album. Within seconds, a set of headphones 430 is presented to our consumer in a convenient box 440 on the vending machine. In a preferred embodiment, the pre-programmed headphones 430 can be used by the consumer to portably enjoy the entire album she has selected, and she cannot modify the album or delete the album or use the headphones for any other purpose.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments of were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A set of headphones comprising:
an electronic media player;
a pre-programmed set of non-erasable, non-rewritable audio data;
a right ear phone;
a left ear phone; and
a battery.

2. The headphones of claim 1 wherein said pre-programmed set of audio data cannot be modified by a user.

3. The headphones of claim 2 wherein said battery is recharchable.

4. The headphones of claim 2 wherein said pre-programmed set of audio data is a single song.

5. The headphones of claim 2 wherein said pre-programmed set of audio data is a plurality of songs.

6. The headphones of claim 2 wherein said pre-programmed set of audio data is a music album comprising a plurality of songs performed by a performance artist.

7. The headphones of claim 2 wherein said pre-programmed set of audio data can be accessed by a user a pre-determined number of times.

8. The headphones of claim 7 wherein said pre-determined number is one.

9. The headphones of claim 2 wherein said pre-programmed set of audio data can be accessed by a user an infinite number of times.

10. A hand-held video display device comprising:
an electronic media player;
a display screen;
a pre-programmed set of non-erasable, non-rewritable video data;
a speaker; and
a battery.

11. The video display device of claim 10 wherein said pre-programmed set of video data cannot be modified by a user.

12. The video display device of claim 10 wherein said pre-programmed set of video data can be accessed a pre-determined number of times.

13. A device for dispensing data comprising:
a means of writing a set of data to an electronic media player, wherein once said set of data is written to said electronic media player, said data is not erasable and not modifiable by a user.

14. The device for dispensing music of claim 13 wherein said data comprises audio data, and wherein said electronic media player is a component of a set of heaphones.

15. The device for dispensing music of claim 14 wherein said set of audio data comprises an album comprising a plurality of songs performed by a musical artist.

16. The device for dispensing data of claim 13 wherein said data comprises video data, and wherein said electronic media player is a component of a hand-held video display device.

17. The device of claim 13 wherein said device is a personal computer.

18. The device of claim 17 wherein said data is accessed via the internet.

19. The device of claim 13 wherein said means are a wireless connection.
